(19) United States
(12) Patent Application Publication
(10) Pub. No.: US 2023/0196943 A1
(43) Pub. Date: Jun. 22, 2023

(54) NARRATIVE TEXT AND VOCAL COMPUTER GAME USER INTERFACE

(71) Applicant: INFINITE REALITY, INC., Norwalk, CT (US)

(72) Inventor: Victor Curtis VARNADO, Brooklyn, NY (US)

(21) Appl. No.: 18/066,631

(22) Filed: Dec. 15, 2022

Related U.S. Application Data
(60) Provisional application No. 63/265,697, filed on Dec. 19, 2021.

(51) Int. Cl. G09B 21/00; A63F 13/54; A63F 13/355

(52) U.S. Cl. CPC G09B 21/006; A63F 13/54; A63F 13/355

(57) ABSTRACT

A narrative engine receives, from a user application providing a user interface via input and output devices of a computing device, object metadata descriptive of the content of the user interface. An augmented description of the user interface is generated, the augmented description including a description of surroundings in the user interface and a listing of actions to be performed to the user interface. The augmented description is presented using the output devices. User input requesting one of the actions is processed. The augmented description is updated based on the user input.

### CROSS-REFERENCE TO RELATED APPLICATIONS

This application claims the benefit of U.S. provisional application Ser. No. 63/265,697 filed Dec. 19, 2021, the disclosure of which is hereby incorporated in its entirety by reference herein.

### TECHNICAL FIELD

Aspects of the disclosure relate to a user interface that interprets displayed or stored computer data as narrative prose. Further aspects relate to computer input gathered through the interface from text or speech-to-text input. Additional aspects relate to the computer interface being accessible to disabled or completely blind players.

### SUMMARY

In one or more illustrative examples, a system includes a computing device including input and output devices. The computing device is programmed to execute a narrative engine to receive, from a user application providing a user interface via the input and output devices, object metadata descriptive of the content of the user interface, generate an augmented description of the user interface, the augmented description including a description of surroundings in the user interface and a listing of actions to be performed to the user interface, present the augmented description using the output devices, process user input requesting one of the actions, and update the augmented description based on the user input.

In one or more illustrative examples, a method includes receiving, from a user application providing a user interface via input and output devices of a computing device, object metadata descriptive of the content of the user interface; generating an augmented description of the user interface, the augmented description including a description of surroundings in the user interface and a listing of actions to be performed to the user interface; presenting the augmented description using the output devices; processing user input requesting one of the actions; and updating the augmented description based on the user input.

In one or more illustrative examples, a non-transitory computer-readable medium includes instructions of a narrative engine that, when executed by one or more processors of a computing device, cause the computing device to perform operations including to receive, from a user application providing a user interface via input and output devices of the computing device, object metadata descriptive of the content of the user interface, including to utilize an application programming interface (API) of the narrative engine to receive the object metadata from the user application, the API including extensions for each type of the user interface to be supported to allow access to the object metadata of that specific user interface type; filter the object metadata using properties of the object metadata to determine relevant objects in the object metadata; generate an augmented description of the user interface using the relevant objects, the augmented description including a description of surroundings in the user interface and a listing of actions to be performed to the user interface; present the augmented description using input and output devices, as one or more of an overlay superimposed on the user interface or audibly as computer-generated speech; process user input requesting one of the actions; update the augmented description based on the user input; and present the updated augmented description using the output devices.

### BRIEF DESCRIPTION OF THE DRAWINGS

FIG. 1 illustrates an example system including a computing device for implementing a narrative interface for operation of a user application;

FIG. 2 illustrates further details of an example implementation of the narrative interface;

FIG. 3 illustrates an example of use of the narrative engine for a 2D game user interface;

FIG. 4 illustrates an example of use of the narrative engine for a 2D application user interface;

FIG. 5 illustrates an example of use of the narrative engine for a 3D game user interface;

FIG. 6 illustrates an example of use of the narrative engine for a store application user interface;

FIG. 7 illustrates an example of object metadata for the purse item shown in the store user interface of FIG. 6;

FIG. 8 illustrates an example process showing a main interface loop for the operation of the narrative engine; and

FIG. 9 illustrates an example process for the narrative engine responding to user input.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

Aspects of the disclose relate to an approach for interpreting computer user interface information and relaying it as narrative descriptive prose which is displayed and spoken out loud by a text-to-speech engine. In an example, a player of a video game may control or trigger events in the computer game through natural speech or text input. Completely blind players may use the interface with audio output and text or vocal input. Deaf players may use the interface with text and/or graphical output and text or vocal input. The speech-to-text and text-to-speech aspects that are utilized may be available in modern smartphones and personal computers.

In an example, the narrative interface may be effective when used with a turn-based computer game. In another example, the narrative interface may be effective when used with a 2D application, such as a word processor or a website. In yet another example, the narrative interface may be effective when used with a 3D application, such as the metaverse or a 3D video game.

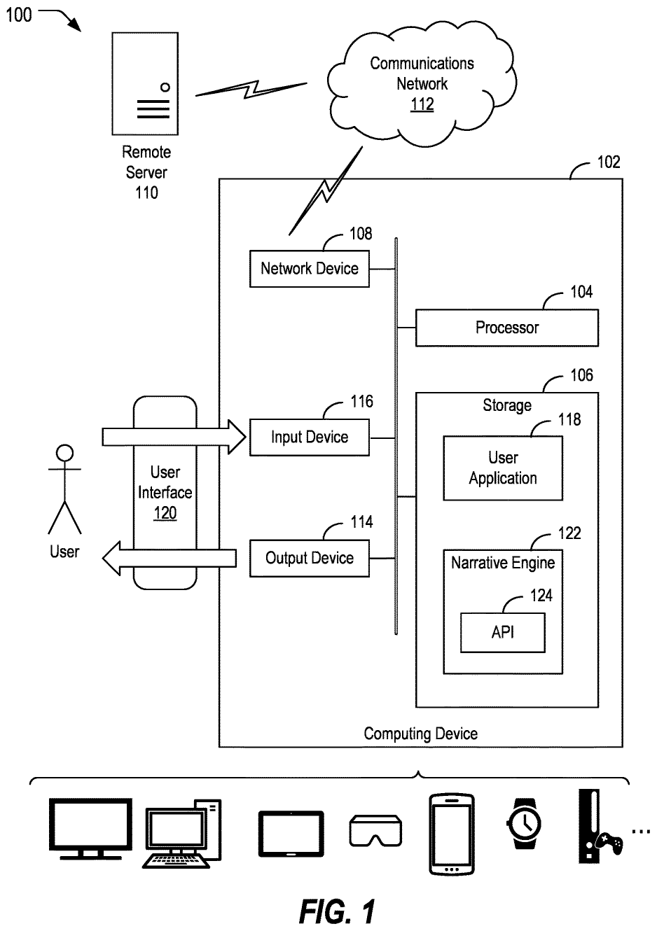

FIG. 1 illustrates an example system 100 including a computing device 102 for implementing a narrative engine 122 for operation of a user application 118. The computing device 102 may be various types of device, such as a smartphone, tablet, desktop computer, smartwatch, video game console, smart television (TV), virtual reality (VR) headset, augmented reality (AR) glasses, etc. Regardless of form, the computing device 102 includes a processor 104 that is operatively connected to a storage 106, a network device 108, an output device 114, and an input device 116. It should be noted that this is merely an example, and computing devices 102 with more, fewer, or different components may be used.

The processor 104 may include one or more integrated circuits that implement the functionality of a central processing unit (CPU) and/or graphics processing unit (GPU). In some examples, the processors 104 are a system on a chip (SoC) that integrates the functionality of the CPU and GPU. The SoC may optionally include other components such as, for example, the storage 106 and the network device 108 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families. While only one processor 104 is shown, it should be noted that in many examines the computing device 102 may include multiple processors 104 having various interconnected functions.

The storage 106 may include both non-volatile memory and volatile memory devices. The non-volatile memory includes solid-state memories, such as negative-AND (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100.

The network devices 108 may each include any of various devices that enable the computing device 102 to send and/or receive data from external devices. Examples of suitable network devices 108 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device.

In an example, the network device 108 may allow the computing device 102 to access one or more remote servers 110 or other devices over a communications network 112. The communications network 112 may one or more interconnected communication networks such as the Internet, a cable television distribution network, a satellite link network, a local area network, and a telephone network, as some non-limiting examples. The remote servers 110 may include devices configured to provide various cloud services to the computing device 102, such as speech-to-text conversion, database access, application and/or data file download, Internet search, etc.

The output device 114 may include a graphical or visual display device, such as an electronic display screen, projector, printer, or any other suitable device that reproduces a graphical display. As another example, the output device 114 may include an audio device, such as a loudspeaker or headphone. As yet a further example, the output device 114 may include a tactile device, such as a braille keyboard or other mechanically device that may be configured to display braille or another physical output that may be touched to be perceived by o a user. For systems that include a GPU, the GPU processor 104 may include hardware and software for display of at least two-dimensional (2D) and optionally three-dimensional (3D) graphics to the output device 114.

The input device 116 may include any of various devices that enable the computing device 102 to receive control input from users. Examples of suitable input devices 116 that receive human interface inputs may include keyboards, mice, trackballs, touchscreens, microphones, headsets, graphics tablets, and the like.

During operation the processor 104 executes stored program instructions that are retrieved from the storage 106. The stored program instructions, accordingly, include software that controls the operation of the processors 104 to perform the operations described herein. This software may include, for example, the one or more user applications 118 and the narrative engine 122.

The user application 118 may include various types of software application executable by the processor 104 that are having a defined user interface 120. As some examples, the user application 118 may be a video game, website, store, productivity application, metaverse component, etc.

The user interface 120 refers to the aspects by which a user and the system 100 interact through use of the input devices 116 and the output devices 114. In some examples, the user application 118 may define a 2D interface, such as that of a website or word processor. In other examples, the user application 118 may define a 3D interface, such as that of a first-person video game or a metaverse application. In yet further examples, the user application 118 may define a textual interface, such as a command line application or a text adventure. Additionally, in some examples, the user interface 120 may be presented via the output devices 114 in a 2D manner, such as on a 2D display screen. In other examples, the user interface 120 may be presented via the output devices 114 in a 3D manner, such as using a VR or AR headset. In yet a further example, the user interface 120 may be presented via the output devices 114 using an audio interface.

The narrative engine 122 may be configured to use bind software actions of the user interface 120 or sequences of actions to natural speech with an API 124, increasing the level of control users have with the user application 118.

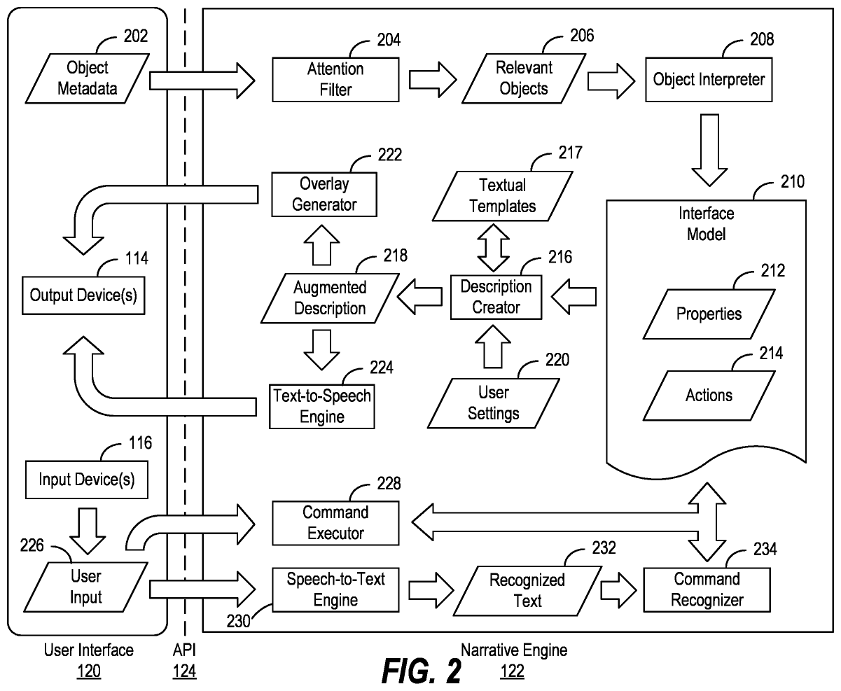

FIG. 2 illustrates further aspects of the narrative engine 122. As shown, the narrative engine 122 may receive object metadata 202 from the user interface 120 via the API 124. The narrative engine 122 may utilize an attention filter 204 to filter the object metadata 202 down to a set of relevant objects 206 relevant to the user. The relevant object 206 may then be provided to an object interpreter 208 to generate an interface model 210. The interface model 210 may describe properties 212 and available actions 214 of the relevant objects 206. A description creator 216 may utilize the interface model 210, text templates 217, and user settings 220 to generate augmented description 218 to be provided to the user interface 120 via the API 124. This may include, for example using an overlay generator 222 to provide the augmented description 218 textually in the user interface 120 and/or using a text-to-speech engine 224 to provide the augmented description 218 audibly in the user interface 120. Additionally, the narrative engine 122 may be configured to receive user input 226 from the user interface 120 via the API 124. This user input 226 may be provided to a command executor 228 to be processed by the user application 118. The user input 226 may also be provided to a speech-to-text engine 230, which may use a command recognizer 234 to identify actions in the interface model 210 to be given to the command executor 228 for processing (e.g., via the API 124 or otherwise).

While an exemplary modularization of the narrative engine 122 is described herein, it should be noted that components of the narrative engine 122 may be incorporated into fewer components or may be combined in fewer components or even into a single component. For instance, while each of the object interpreter 208, description creator 216, overlay generator 222, text-to-speech engine 224, command executor 228, speech-to-text engine 230, a command recognizer 234, and a command executor 228 are described separately, these components may be implemented separately or in combination by one or more controllers in hardware and/or a combination of software and hardware.

The object metadata 202 may refer to any exposed or otherwise available information defining aspects of the interface elements in the user interface 120. For a 2D interface, these interface elements may refer to 2D elements such as windows, dialog boxes, buttons, sliders, text boxes, web page links, etc. For a 3D interface, these interface elements may refer to 3D mesh objects in a 3D scene, such as trees, houses, avatars, models of vehicles, etc. For a text-based interface, the interface elements may refer to textual blocks, such as user prompts, as well as other text-based information, such as the response to a help command used to surface available text commands.

The API 124 may include computer code used to allow the narrative engine 122 to receive the object metadata 202 from the user interface 120. In an example, for a 3D scene such as that rendered in Unity or another 3D engine, each object being rendered may have object metadata 202. This object metadata 202 may be accessed by the narrative engine 122 via the API 124. In another example, for a 2D webpage, the hypertext transfer protocol (HTTP) markup of the web page may include or otherwise define the object metadata 202 that may be read by the narrative engine 122 via the API 124. In yet another example, for a windows application, the window location, text, and other attributes may be captured by the API 124 via an enumeration of the windows on the desktop and/or via using other operating system (OS) level interface functions. In still a further example, for a console application, the console buffer text may be read by the narrative engines 122 via the API 124. In some examples, the API 124 may require a shim or extension to be created for each type of new user interface 120 to be supported, to allow the narrative engine 122 to be able to access the object metadata 202 of that specific user interface 120 type. For instance, if rendered Java applications were to be supported, then a shim or extension may be added to the API 124 to allow for the rendered Java control information to be exposed to the narrative engine 122.

The attention filter 204 may be configured to filter the object metadata 202 into relevant objects 206. In an example, the attention filter 204 may simply allow for the processing of all object metadata 202. However, this may not be practical for a complicated interface or for a crowded 3D scene. Moreover, it may be desirable to limit the scope of the interface elements that are being considered based on criteria relevant to the user's attention, such as the location of the user within a 3D scene, a location of the mouse pointer in a 2D interface, the current task being performed by the user, etc. In an example, the attention filter 204 may filter the object metadata 202 based on the properties of the object metadata 202. Continuing with the example of the 3D location, the attention filter 204 may limit the object metadata 202 to objects that are within a predefined distance from the user or an avatar of the user, and/or within the field of view of the user. For a 2D example, the attention filter 204 may limit the object metadata 202 to controls that are within a predefined 2D distance from the mouse cursor, and/or to interface elements that are enabled.

The object interpreter 208 be configured to receive the relevant objects 206 and to compile the interface model 210 based on the received relevant objects 206. In an example, the object interpreter 208 may generate the interface model 210 as including the properties 212 and available actions 214 of the relevant objects 206 as filtered by the attention filter 204. In doing so, the object interpreter 208 may create a set of information that may be used for both augmenting the content in the user interface 120 as well as to improve the user selection of commands.

In an example of a 2D interface, the object metadata 202 may include property 212 information such as control properties 212 (e.g., name, owner, screen location, text, button identifier (ID), link reference ID, etc.). The object metadata 202 may also include available actions 214 such as to press or activate a button, to scroll to a location, to receive text, to remove text. In an example of a 3D interface, the object metadata 202 may include property 212 information (e.g., mesh name, creator ID, model ID, color, shading, texture, size, location, etc.). The available actions 214 may include aspects such as to move the object, to open a door, to start a car, to adjust the speed or direction of the car, etc. In an example of a text interface, the object metadata 202 may include property 212 information such as the text of a prompt. The available actions 214 may include text commands exposed by the command line. For instance, a help command may be issued to surface any available text commands.

The description creator 216 may be configured to generate augmented description 218 of the interface model 210 for augmenting the user interface 120. In an example, the description creator 216 may generate natural language describing the properties 212 of the relevant objects 206. In another example, the description creators 216 may generate natural language describing the available actions 214 of the relevant objects 206.

In an example, the description creator 216 may make use of text templates 217 to provide natural language descriptions based on the metadata of the relevant objects 206. Each template 217 may include natural language text, along with one or more placeholders for values of properties 212 or available actions 214 of the relevant objects 206 to be described. A template 217 may apply to a relevant object 206 or to a set of relevant objects 206 if the placeholders for the values are specified by the metadata of the relevant objects 206. As shown in the examples herein, the names of the properties 212 and available actions 214 are specified in the templates 217 within square brackets, but that is merely an example and other approaches for parameterized text may be used (such as use of AI techniques to generate natural language text from prompt information).

In an example, to generate information descriptive of the environment, the description creator 216 may utilize a template 217 such as “You are using [application name],” or “You are located near [object name]” or “You are facing in [direction],” or “There is a [object name] nearby that is [attribute].” For instance, the template 217 “You are using [application name]” may be used if one of the relevant objects 206 in the interface model 210 has an application name property 212 specified.

In another example, to generate a list of the available actions 214, the description creator 216 may utilize a template 217 such as “From here, you can [list of available actions 214 formatted into a comma-delineated list],” where each of the available actions 214 may be listed based on metadata such as command name, tooltip text, attribute name, etc. Aspects of the creation of the augmented description 218 may also be based on user settings 220. For example, the user settings 220 may indicate a level of verbosity for the generation of the augmented description 218 (e.g., using templates 217 that are complete sentences vs a terse listing of attributes).

The overlay generator 222 may be configured to visually provide the augmented description 218 to the user via the output device(s) 114 of the user interface 120. In an example, the overlay generator 222 may provide the augmented description 218 on top of the existing display as textual information (e.g., in a high contrast color and/or font).

The text-to-speech engine 224 may be configured to audibly provide the augmented description 218 to the user via the output device(s) 114 of the user interface 120. In an example, the text-to-speech engine 224 may use any of various speech synthesis techniques to converts normal language text into speech, which may then be played via speakers, headphones or other audio output devices 114.

In some examples, the user settings 220 may further indicate how the description creator 216 should provide the augmented description 218 to the user. These user setting 220 may be based on the level or type of disability of the user. For instance, if the user is vision impaired, then the user settings 220 may indicate for the augmented description 218 to be spoken to the user via the text-to-speech engine 224. Or, if the user is hearing impaired, then the user settings 220 may indicate for the augmented description 218 to be displayed to the user via the overlay generator 222. It should be noted these settings may be used in situations other than ones in which the user has a disability, e.g., to allow for use of an application in a loud room by using the overlay generator 222 to explain information that may not be audible due to the noise level.

The command executor 228 may be configured to cause the narrative engine 122 to perform available actions 214 that are requested by the user. The command executor 228 may receive user input 226 from one or more input devices 116 of the user interface 120. In some examples, the user input 226 may include actions that the user application 118 may understand without processing by the narrative engine 122. For instance, the user input 226 may include pressing a control that is mapped to one of the available actions 214. In such an example, the command executor 228 of the narrative engine 122 may simply pass the user input 226 to the user application 118 for processing.

In other examples, the user input 226 may be an indication to perform a command indicated by the augmented description 218, but in a manner that the user application 118 may be unable to process. For instance, the augmented description 218 may indicate that the user may say a particular command to cause it to be executed. However, the user application 118 may lack voice support. Accordingly, the user input 226 may additionally be provided to a speech-to-text engine 230 of the narrative engine 122, which may process the user input 226 into a textual representation, referred to herein as recognized text 232.

The command recognizer 234 may receive the recognized text 232 and may process recognized text 232 to identify which, if any, of the available actions 214 to perform. For example, the command recognizer 234 may scan the recognized text 232 for action words, e.g., the names of the available actions 214 in the interface model 210. In another example, the command recognizer 234 may scan for predefined verbs or other actions, such as “help.” If such an available action 214 is found, then the command recognizer 234 may instruct the command executor 228 to perform the spoken available action 214.

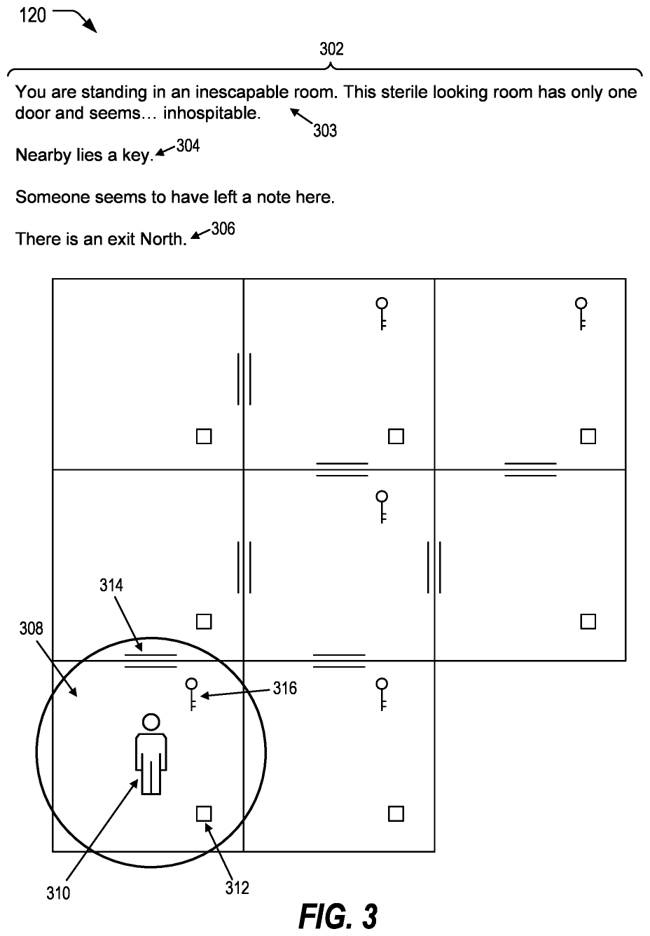

FIG. 3 illustrates an example of use of the narrative engine 122 for a 2D game user interface 120. The example shows a dynamically created text block 302 including the augmented description 218 which is displayed in the user interface 120 along with the 2D game user application 118.

As shown, the user interface 120 includes various objects presented to a screen output device 114 by a game user application 118. Each of the objects may expose various object metadata 202, which may be accessed by the narrative engine 122 via the API 124. For instance, the API 124 may be configured to allow the game objects of the user interface 120 to be enumerated by the narrative engine 122. Based on this received data, the narrative engine 122 may construct the augmented description 218. The augmented description 218 may be displayed in the dynamically created text block 302, which is shown on a display output device 114.

In many examples, the dynamically created text block 302 may first include description of the surroundings of the user, followed by the available actions 214. Each element of the dynamically created text block 302 refers to the position of a player avatar 310, game objects 312 that are within line of sight 308 of the player avatar 310, or descriptions of audio events. For instance, the dynamically created text block 302 begins with a phrase 303 “You are standing in an inescapable room.” The text of this phrase 303 may be retrieved from a description of audio events that occur where the user is located. A phrase 304 “Nearby lies a key.” in the dynamically created text block 302 refers to a key game object 316 which is within the area marked as the line of sight 308 of the player avatar 310. A phrase 306 “There is an exit north.” in the dynamically created text block 302 refers directly to a door game object 314 which is within the area marked as the player avatar 310's line of sight 308.

The attention filter 204 may receive the location of the player avatar 310, and may use the player avatar 310 and/or the line of sight 308 to determine the relevant objects 206 from the object metadata 202. In an example, the attention filter 204 may define the line of sight 308 to include, as the relevant objects 206, any interface elements that have object metadata 202 indicating that the element is in the same room as the current room location of the player avatar 310 (e.g., the door game object 314, the key game object 316). These relevant objects 206 may be included in the interface model 210 by the object interpreter 208. Other object, such as keys in other rooms or doorways in other rooms, are not relevant and are not included in the augmented description 218.

The augmented description 218 text may be compiled using textual templates 217 into which the properties 212 of the relevant objects 206 of the interface model 210 are a fit. For instance, a template 217 “Nearby is a/an [object name]” may be utilized for the key game object 316 as that object has an object name property 212 and is within the line of sight 308 of the player avatar 310.

Although not shown in the dynamically created text block 302, the interface model 210 may further include one or more available actions 214. These may be available as commands that may be invoked by the user. For instance, the key game object 316 may specify a pick-up method, and this method may be added to the available actions 214 of the interface model 210 such that if the user says a command including the key and the pick-up action, that the command recognizer 234 will identify the requested command and send it to the command executor 228 for processing.

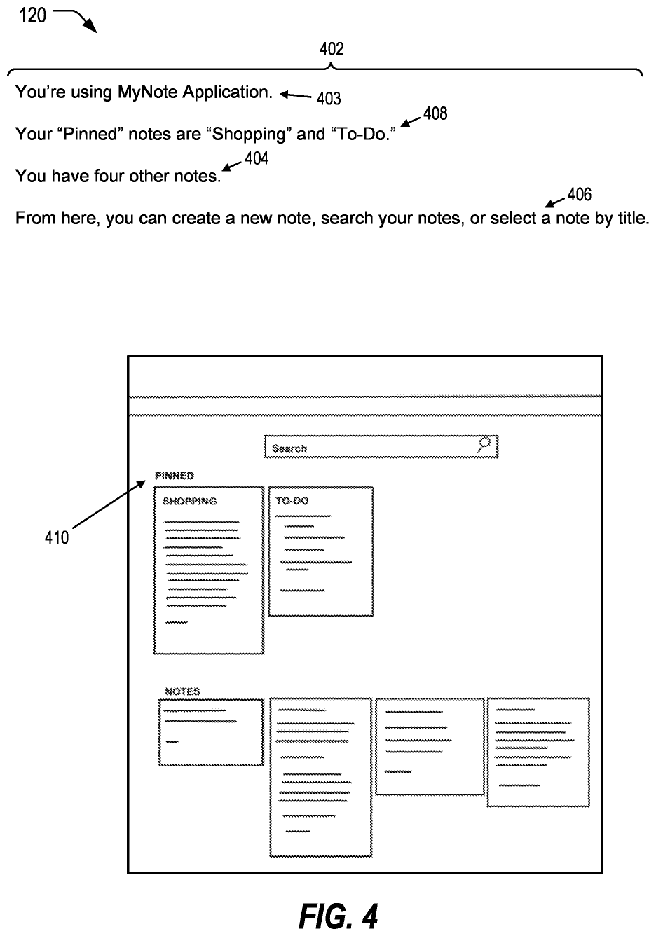

FIG. 4 illustrates an example of use of the narrative engine 122 for a 2D application user interface 120. The example shows a dynamically created text block 402 including the augmented description 218, which is displayed in the user interface 120 along with the 2D application user application 118.

As shown, the dynamically created text block 402 includes various information descriptive of the 2D user application 118. For instance, the dynamically created text block 402 may include a phrase 404 that indicates the name of the application. This may be generated using the name of the in-focus application retrieved from the relevant objects 206, applied into a template 217 that receives the application name, such as “You're using [application name].”

Additional elements of the dynamically created text block 402 may refer to a potential user actions represented by relevant objects 206 in the software (e.g., as shown in phrase 404), frequently used menu items or functions (e.g., as shown in phrase 406). A phrase 408 “Your ‘Pinned’ notes are ‘Shopping’ and ‘To-Do.” in the dynamically created text block 402 may be prioritized and placed earlier in the dynamically created text block 402 because the user has pinned those items as shown in the user interface 120 by element 410, indicating that those notes are relatively more important.

In many examples, the dynamically created text block 402 may first include description of the context of the user, followed by the available actions 214. Here, the available actions 214 include the menu commands that are available in the user interface 120, such as to create a new note, to search the notes, or to select a note by title. It should be noted that this ordering is merely an example and other orderings of the properties 212 and available actions 214 may be used.

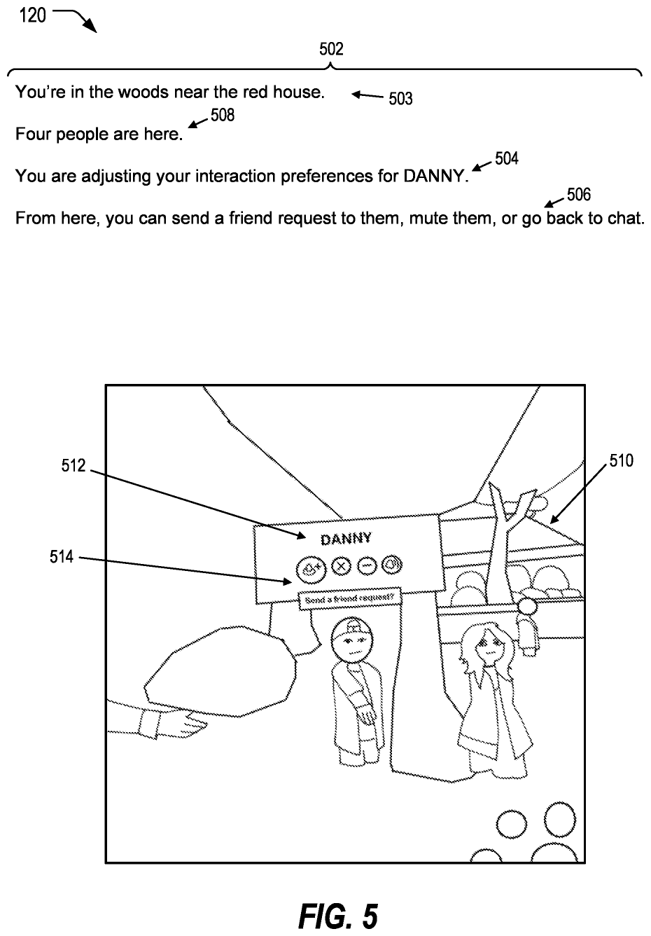

FIG. 5 illustrates an example of use of the narrative engine 122 for a 3D game user interface 120. The example shows a dynamically created text block 502 including the augmented description 218, which is displayed in the user interface 120 along with the 3D application user application 118.

As shown, the dynamically created text block 502 includes various information descriptive of the 3D user application 118. For instance, the dynamically created text block 502 may include a phrase 503 that indicates a location of the user in the 3D application. This may be chosen based on the closest relevant objects 206 to the user location. Here, a house object 510 is closest to the user. In some examples, the section of the map in which the user is located may be marked with a property 212 such as map area, and the chosen object may be marked with a property 212 such as landmark object, and the narrative engine 122 may use a template 217 such as “You're in the [map area] near the [landmark object.]”

In another example, the dynamically created text block 502 may include a phrase 508 descriptive of the count of other users included in the interface model 210. For instance, a template 217 may be used such as “[number] [object type] are here,” where object type is a type property 212 of one or more of the relevant objects 206 in the interface model 210, and number is a count of those relevant objects 206 having that same type.

The dynamically created text block 502 may also include context-aware information with respect to an ongoing interaction that the user is having with the user application 118. In the example, one of the users (Danny) has been selected, and a menu of commands relevant to that user is available in the user interface 120. Thus, a phrase 504 may be included in the dynamically created text block 502 to explain the context that interaction with the Danny user is being adjusted. Additionally, a phrase 506 may be provided including a list of the available actions 214, e.g., “From here, you can [list of available actions 214 formatted into a comma-delineated list],” where each of the available actions 214 may be listed based method metadata the selected relevant object 206 of Danny. Thus, here again the augmented description 218 first includes include description of the context of the user, followed by the available actions 214, although other orderings are possible.

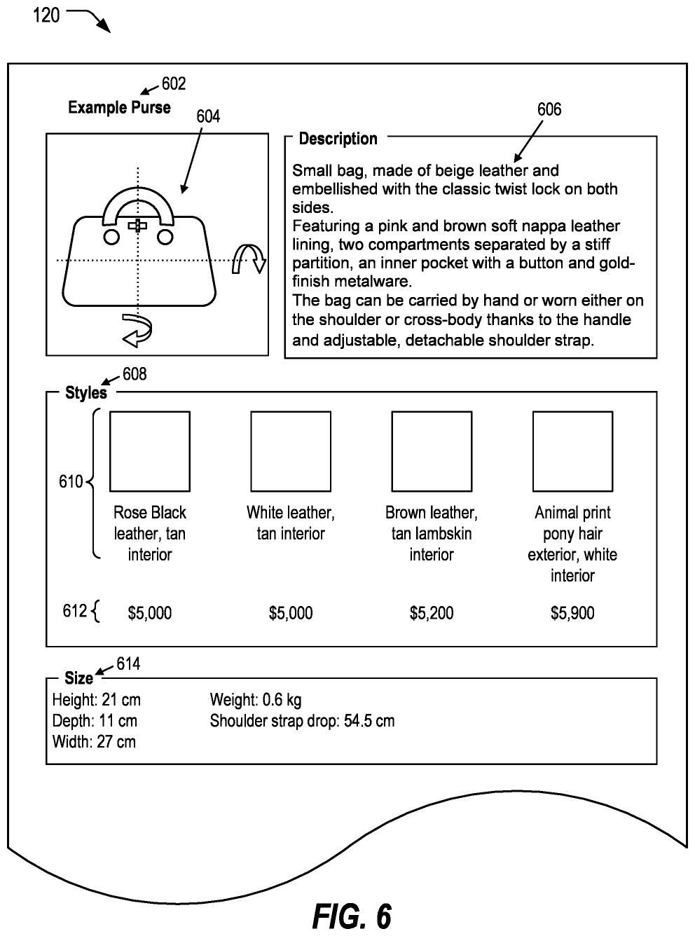

FIG. 6 illustrates an example of use of the narrative engine 122 for a store application user interface 120. The store may allow the user to shop for items, such as a purse as shown in the example. As some examples, the store user interfaces 120 may be presented to the user in a web application or via a mobile app. In another example, the store user interface 120 may be presented as a portion of a 3D user interface 120 such as a metaverse store. In the metaverse example, the user may have entered a store level and moved to a merchandise store, e.g., via setting the store as the destination using voice commands to a virtual assistant.

The user may provide a command, such as asking for purses of a specific brand, via with natural spoken voice or text. The user interface 120 may be provided responsive to that command. As shown, a name 602 of the purse is presented with a mesh 604 of the purse, a description 606 of the purse, and a listing of various styles 608. Each of the styles 608 may include a texture 610 and a price 612 corresponding to that style 608. The user interface 120 may also include size 614 information for the item as well, such as height, depth, width, weight, shoulder strap drop, etc.

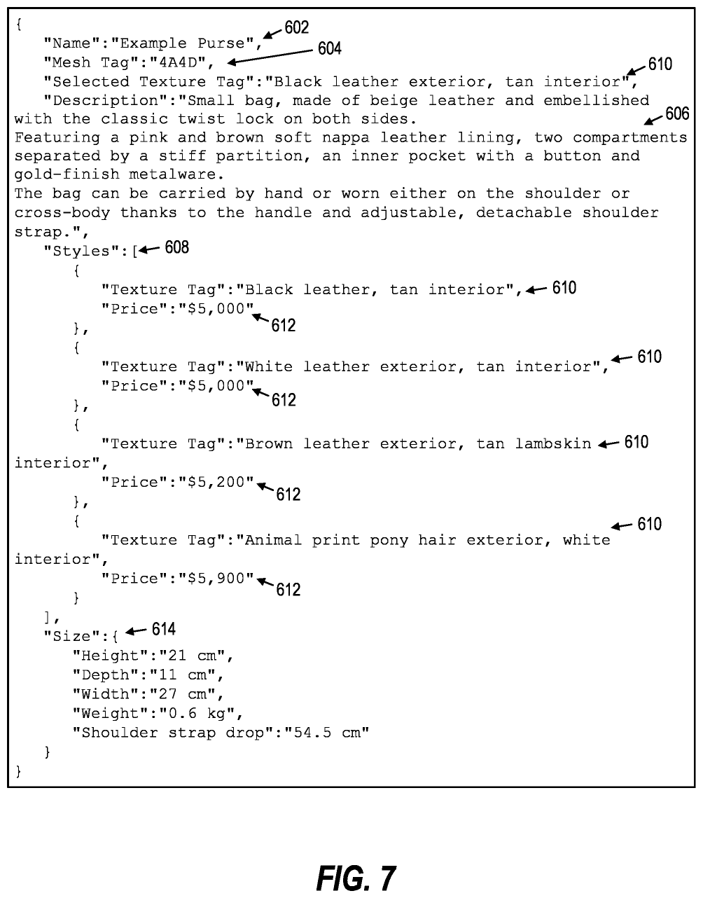

FIG. 7 illustrates an example of object metadata 202 for the purse item shown in the store user interface 120 of FIG. 6. For example, the object metadata 202 may specify the name 602 of the purse, the mesh 604 corresponding to the purse, the description 606 of the purse, and a set of styles 608 for the purse, each style 608 including a respective texture 610 and price 612. Additionally, the currently selected texture 610 may be specified in a selected texture tag to explain how the mesh 604 is to be textured.

The object metadata 202 may be used to render the user interface 120 itself. Additionally, the object metadata 202 may be received from the user interfaces 120 via the API 124 and compiled by the attention filter 204 and object interpreter 208 into an interface model 210 to allow the narrative engine 122 to provide additional accessible features to the presentation of the store user interface 120. It should be noted that while the object metadata 202 is shown in JavaScript object notation (JSON), this is merely one example and various formats of object metadata 202 may be used.

For example, the narrative engine 122 receiving the narrative engine 122 may utilize the attention filter 204 to filter the object metadata 202 down to the relevant objects 206 that are available in the purse portion of the store, while the object interpreter 208 to generate an interface model 210 for the relevant objects 206. Responsive to the user interface 120 being displayed, the narrative engine 122 may construct the augmented description 218. In an example, the augmented description 218 may include an augmented description 218 indicating, in natural language, the name 602 of the purse, the description 606 of the purse, and the listing of various styles 608. The narrative engine 122 may begin to speak the augmented description 218 using the text-to-speech engine 224.

In an example interaction, the user may interrupt before the complete augmented description 218 is read by the narrative engine 122, and may say “Do you have the brown leather?” Responsive to receipt of the user input 226, the narrative engine 122 may utilize the speech-to-text engine 230 to convert the user input 226 into recognized text 232. The command recognizer 234 may utilize the recognized text 232 to identify available actions 214. In an example, the list of styles 608 may be compiled into available actions 214 of the interface model 210 supporting selection from the styles 608. The available actions 214 may include a single style 608 that includes the word “brown leather.” The narrative engines 122 may construct a response stating, “The styles include ‘Brown leather exterior, tan lambskin interior’. The price of this style is $5,200”

In a further example interaction, the user may ask “What is the size?” Here again, the narrative engine 122 may utilize the speech-to-text engine 230 to convert the user input 226 into recognized text 232. The command recognizer 234 may utilize the recognized text 232 to identify that there is a size property 212 in the interface model 210 and may construct a phase to say the size 614 of the purse, e.g., “The purse has a height of 21 cm, a depth of 11 cm, a width of 27 cm, a weight of 0.6 kg, and a shoulder strap drop of 54.5 cm.” Significantly, the answer to the question may be gleaned from the interface model 210, without additional knowledge by the narrative engine 122 of the purse object.

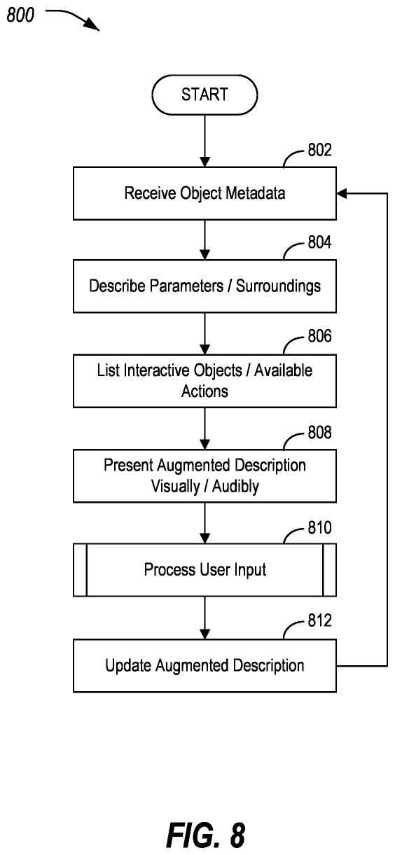

FIG. 8 illustrates an example process 800 showing a main interface loop for the operation of the narrative engine 122. In an example the process 800 may be performed by the computing device 102 executing the narrative engine 122 and the user application 118 as discussed in detail herein.

At operation 802, the narrative engine 122 receives object metadata 202. In an example, the narrative engine 122 uses the API 124 to capture or otherwise receive object metadata 202 from the user interface 120. In an example, for a 3D scene such as that rendered in Unity or another 3D engine, each object being rendered may have object metadata 202 which may be captured by the API 124. In another example, for a 2D webpage, the HTTP markup of the web page may include or otherwise define the object metadata 202 that may be read by the narrative engine 122 via the API 124. In yet another example, windows location, text, and other attributes may be captured by the API 124 via an enumeration of the windows on the desktop and/or via using other OS level interface functions. In still a further example, for a console application, the console buffer text may be read by the narrative engines 122 visa the API 124.

At operation 804, the narrative engine 122 describes surroundings of the user. This may involve filtering the object metadata 202 using the attention filter 204 to determine the relevant objects 206, using the object interpreter 208 to construct the interface model 210, and using the description creator 216 to generate augmented description 218 based on the properties 212 of the relevant objects 206.

In an example, the attention filter 204 of the narrative engine 122 may filter the object metadata 202 received at operation 802 into relevant objects 206. For a video game, this object metadata 202 may include game objects 312 in the line of sight 308 or otherwise within proximity to the user, however defined. For a 2D application (e.g., a word processor, another productivity application, a webpage, etc.) the object metadata 202 may refer to the windows, dialog boxes, buttons, sliders, text boxes, web page links, etc. that make up the user interface 120. For a console application, the object metadata 202 may include the text displayed to the console. In some examples, the attention filter 204 may simply allow for the processing of all object metadata 202. In other examples, to limit the context down to more relevant surroundings, the attention filter 204 may filter the object metadata 202 based on the properties 212 of the object metadata 202, such as to limit the object metadata 202 to objects that are within a predefined distance from the user, and/or within the field of view of the user, to limit the object metadata 202 to controls that are within a predefined 2D distance from the mouse cursor, and/or to limit the object metadata 202 to interface elements that are enabled.

The description creator 216 may generate natural language describing the properties 212 of the relevant objects 206. In another example, the description creators 216 may generate natural language describing the available actions 214 of the relevant objects 206. The description creator 216 may make use of text templates 217 to provide natural language descriptions based on the metadata of the relevant objects 206. Each template 217 may include natural language text, along with one or more placeholders for values of properties 212 or available actions 214 of the relevant objects 206 to be described. For instance, to generate information descriptive of the environment, the description creator 216 may utilize a template 217 such as “You are using [application name],” or “You are located near [object name]” or “You are facing in [direction],” or “There is a [object name] nearby that is [attribute].”

At operation 806, the narrative engine 122 lists the interactive objects in the user interface 120. Similar to at operation 804, the narrative engine 122 may again make use of the description creator 216 to generate augmented description 218 based on the properties 212 of the relevant objects 206. However, in this instance the available actions 214 may be used to build a list of available commands that could be performed in the user interface 120 by the user. For example, phrases may be provided including a list of the available actions 214, e.g., “From here, you can [list of available actions 214 formatted into a comma-delineated list],” where each of the available actions 214 may be listed based method metadata the selected relevant object 206. For instance, if a key game object 316 has a pick-up available action 214 in the interface model 210, then the description creator 216 may add a sentence or phrase to the augmented description 218 indicating that a command to pick up the key is available.

At operation 810, the narrative engine 122 presents the augmented description 218 in the user interface 120. In an example, the narrative engine 122 may utilize a text-to-speech engine 224 to convert the augmented description 218 into audio from a simulated human and may provide that audio to an audio output device 114 such as a loudspeaker or headphone. In another example, the narrative engine 122 may utilize an overlay generator 222 to create a visual textual representation of the augmented description 218 to be provided on top of the existing context of the user interface 120 via the display output device 114. The user settings 220 may be utilized to determine whether to present the augmented description 218 visually, audibly, both, or in some other manner. For instance, the user setting 220 may define how to present the augmented description 218 based on the level or type of disability of the user.

At operation 812, the narrative engine 122 processes user input 226. This processing may include receiving the user input 226 from the user interface 120 via the API 124, providing the user input 226 to the speech-to-text engine 230 to generate recognized text 232, which may be used by the command recognizer 234 to identify actions in the interface model 210 to be given to the command executor 228 for processing (e.g., via the API 124 or otherwise). Further aspects of processing of the user input 226 are discussed in detail with respect to the process 900.

At operation 814, the narrative engine 122 updates based on user input 226. In an example, the user input 226 at operation 812 may include the execution of one or more commands that may change the state of the user interface 120. This may cause the narrative engine 122 to return to operation 802 to again the object metadata 202, update the interface model 210, generate a new augmented description 218, etc. It should be noted that in some examples, control may pass to operation 802 based on other conditions, such as the narrative engine 122 detecting a change in the user interface 120 that is not resultant from user input 226 or based on expiration of a periodic timeout after which the narrative engine 122 performs an update.

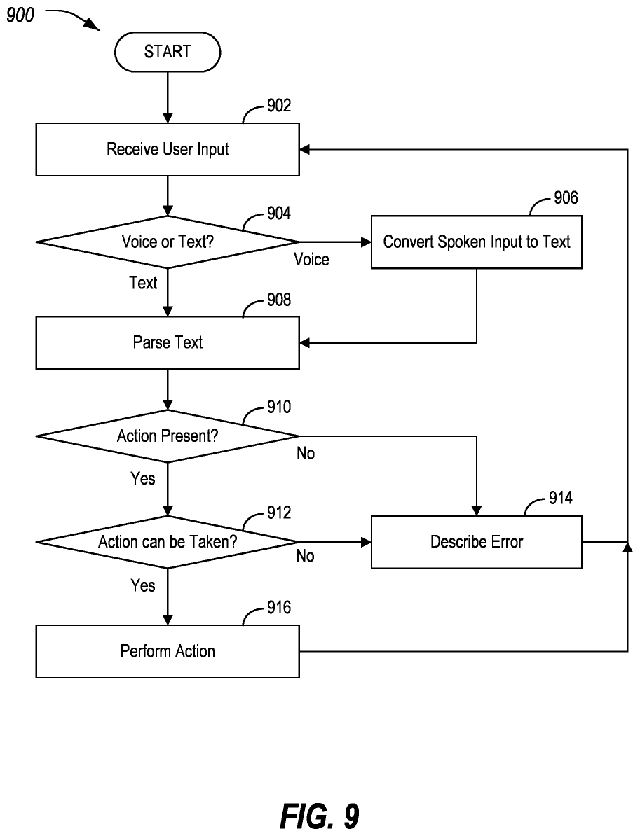

FIG. 9 illustrates an example process 900 for the narrative engine 122 responding to user input 226. As with the process 800, the process 900 may be performed by the computing device 102 executing the narrative engine 122 and the user application 118 as discussed in detail herein.

At operation 902, the narrative engine 122 receives user input 226. The user input 226 may be received to the computing device 102 via one or more input devices 116. The user input 226 may be provided by the computing device 102 to the user application 118. The user input 226 may also be provided to the narrative engine 122 for additional processing to facilitate the operation of the narrative interface.

At operation 904, the narrative engine 122 determines whether the user input 226 includes voice or text. If the user input 226 is voice input, e.g., received from a microphone, control proceeds to operation 906. Otherwise, control proceeds to operation 908.

At operation 906, the narrative engine 122 converts the voice into recognized text 232. In an example the narrative engine 122 utilizes the speech-to-text engine 230 to parse the user input 226 into a textual representation as the recognized text 232. After operation 906, control proceeds to operation 908.

At operation 908, the narrative engine 122 parses the recognized text 232. In an example, the command recognizer 234 may receive the recognized text 232 and may process recognized text 232 to identify which, if any, of the available actions 214 to perform. For example, the command recognizer 234 may scan the recognized text 232 for action words, e.g., the names of the available actions 214 in the interface model 210. In another example, the command recognizer 234 may scan for predefined verbs or other actions, such as “help.”

At operation 910, the narrative engine 122 determines whether an action is present. If such an available action 214 is found, then control passes to operation 912. If not, control passes to operation 914. At operation 912, the narrative engine 122 determines whether the action can be taken. In an example, the narrative engine 122 may confirm that the action can occur within the architecture of the user application 118. If not, control passes to operation 914.

At operation 914, the narrative engine 122 describes an error that occurred. In an example, the error may indicate that no action was detected in the recognized text 232. In such an example, the error may state that no available action 214 was found in the recognized text 232. In another example, the error may indicate that the available action 214 cannot be performed to the indicated relevant object 206. As one example, the recognized text 232 “pick up the car” may not be possible even though the action “pick up” is available for other objects such as keys”. In such an example, the error may state that the car does not support the action pick up. In some examples this error may be provided back to the user via the text-to-speech engine 224 or via the overlay generator 222.

At operation 916, the narrative engine 122 performs the action. For instance, the narrative engine 122 may direct the command recognizer 234 to instruct the command executor 228 to perform the spoken available action 214. After operation 916, control returns to operation 902.

It should be noted that while the processes 800-900 are shown in a loopwise sequence, in many examples the process 800-900 may be performed continuously. It should also be noted that one or more of the operations of the processes 800-900 may be executed concurrently, and/or out of order from as shown in the process 800-900.

Thus, the narrative engine 122 may evaluate user application 118 information and presents it as text and/or as spoken audio to the user. The narrative engine 122 then processes user input 226 such as text or spoken audio from the user. This input may then be used to trigger application functionality.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system, comprising:
a computing device including input and output devices, the computing device being programmed to execute a narrative engine to
receive, from a user application providing a user interface via the input and output devices, object metadata descriptive of the content of the user interface,
generate an augmented description of the user interface, the augmented description including a description of surroundings in the user interface and a listing of actions to be performed to the user interface,
present the augmented description using the output devices,
process user input requesting one of the actions, and
update the augmented description based on the user input.

2. The system of claim 1, wherein the computing device is further programmed to:
utilize an application programming interface (API) to receive the object metadata from the user application, the API including extensions for each type of the user interface to be supported, to allow the narrative engine to access the object metadata of that specific user interface type.

3. The system of claim 2, wherein the user interface is a 3D user interface is rendered by a 3D engine, elements of the 3D user interface are rendered according to the object metadata, and the object metadata is accessed by the narrative engine via the API.

4. The system of claim 2, wherein the user interface is a web user interface rendered by a web browser, elements of the web user interface are rendered according to the object metadata included in hypertext transfer protocol (HTTP) markup, and the object metadata is accessed from the HTTP markup by the narrative engine via the API.

5. The system of claim 2, wherein the user interface is a console application user interface, and the object metadata is accessed from a console text buffer of the console application by the narrative engine via the API.

6. The system of claim 1, wherein the augmented description is presented as an overlay superimposed on the user interface.

7. The system of claim 1, wherein the augmented description is presented audibly as computer-generated speech.

8. The system of claim 1, wherein the narrative engine includes user settings that define how to present the augmented description based on a level or type of disability of a user of the narrative engine.

9. The system of claim 1, wherein the narrative engine is further programmed to:
filter, by an attention filter, the object metadata using properties of the object metadata to determine relevant objects in the object metadata, including one or more of to:
limit the object metadata to elements of the user interface within a predefined distance from an avatar of a user,
limit the object metadata to the elements of the user interface within a field of view of the user, or
limit the object metadata to the elements of the user interface that are within a predefined 2D distance from a mouse cursor, limit the object metadata to the elements of the user interface that are enabled.

10. The system of claim 9, wherein the narrative engine is further programmed to:
construct an interface model descriptive of the properties and available actions of the relevant objects; and
use a description creator to generate the description of the surroundings based on the properties of the relevant objects, and to generate the listing of actions based on the available actions of the relevant objects.

11. The system of claim 10, wherein the description creator is configured to generate the augmented description using templates that include natural language text and placeholders for values of the properties or the available actions of the relevant objects to be described.

12. The system of claim 10, wherein the narrative engine is further programmed to:
utilize a speech-to-text engine to convert the user input into recognized text;
scan the recognized text for names of the available actions in the interface model; and
instruct the user application to perform the named available action that was spoken.

13. A method, comprising:
receiving, from a user application providing a user interface via input and output devices of a computing device, object metadata descriptive of the content of the user interface;
generating an augmented description of the user interface, the augmented description including a description of surroundings in the user interface and a listing of actions to be performed to the user interface;
presenting the augmented description using the output devices;
processing user input requesting one of the actions; and
updating the augmented description based on the user input.

14. The method of claim 13, further comprising:
utilizing an application programming interface (API) to receive the object metadata from the user application, the API including extensions for each type of the user interface to be supported to allow access to the object metadata of that specific user interface type.

15. The method of claim 13, wherein the augmented description is presented as an overlay superimposed on the user interface.

16. The method of claim 13, wherein the augmented description is presented audibly as computer-generated speech.

17. The method of claim 13, further comprising presenting the augmented description according to user settings indicating a level or type of disability of a user.

18. The method of claim 13, further comprising:
filtering the object metadata using properties of the object metadata to determine relevant objects in the object metadata, including one or more of:
limiting the object metadata to elements of the user interface within a predefined distance from an avatar of a user,
limiting the object metadata to the elements of the user interface within a field of view of the user, or
limiting the object metadata to the elements of the user interface that are within a predefined 2D distance from a mouse cursor, limit the object metadata to the elements of the user interface that are enabled.

19. The method of claim 18, further comprising:
constructing an interface model descriptive of the properties and available actions of the relevant objects; and
using a description creator to generate the description of the surroundings based on the properties of the relevant objects, and to generate the listing of actions based on the available actions of the relevant objects.

20. The method of claim 19, further comprising generating the augmented description using templates that include natural language text and placeholders for values of the properties or the available actions of the relevant objects to be described.

21. The method of claim 19, further comprising:
utilizing a speech-to-text engine to convert the user input into recognized text;
scanning the recognized text for names of the available actions in the interface model; and
instructing the user application to perform the named available action that was spoken.

22. A non-transitory computer-readable medium comprising instructions of a narrative engine that, when executed by one or more processors of a computing device, cause the computing device to perform operations including to:
receive, from a user application providing a user interface via input and output devices of the computing device, object metadata descriptive of the content of the user interface, including to utilize an API of the narrative engine to receive the object metadata from the user application, the API including extensions for each type of the user interface to be supported to allow access to the object metadata of that specific user interface type;
filter the object metadata using properties of the object metadata to determine relevant objects in the object metadata;
generate an augmented description of the user interface using the relevant objects, the augmented description including a description of surroundings in the user interface and a listing of actions to be performed to the user interface;
present the augmented description using the output devices, as one or more of an overlay superimposed on the user interface or audibly as computer-generated speech;
process user input requesting one of the actions;
update the augmented description based on the user input; and
present the updated augmented description using the output devices.
